(19) United States
(12) Patent Application Publication
(10) Pub. No.: US 2026/0350967 A1
(43) Pub. Date: Nov. 5, 2026

(54) DEVICE AND METHOD FOR AUTOMATICALLY GENERATING A SEMANTIC LABEL MAP BASED ON KEYFRAME SPATIAL INFORMATION

(71) Applicants: Hyundai Motor Company, Seoul (KR); Kia Corporation, Seoul (KR)

(72) Inventor: Changyo Lee, Hwaseong-si (KR)

(21) Appl. No.: 19/741,509

(22) Filed: Jul. 14, 2026

Related U.S. Application Data
(63) Continuation-in-part of application No. 19/338,598, filed on Sep. 24, 2025.
(63) Continuation-in-part of application No. 19/098,058, filed on Apr. 2, 2025.

(30) Foreign Application Priority Data
Oct. 17, 2024 (KR) 10-2024-0142400
Apr. 14, 2025 (KR) 10-2025-0047863

(51) Int. Cl. G06V 10/764; B25J 19/02; G06T 7/70

(52) U.S. Cl. CPC G06V 10/764; B25J 19/023; G06T 7/70

(57) ABSTRACT

In an embodiment a device includes one or more processors, and one or more non-transitory computer-readable media with instructions stored thereon, wherein the instructions, when executed by the one or more processors, enable the device to perform obtaining keyframe data generated through mapping by a robot and global point data of a semantic map, generating a first keyframe data (KD)-tree based on the global point data, extracting at global point adjacent to a keyframe by using the first KD-tree and the keyframe data, assigning a keyframe label of the keyframe to the global point, determining a score of the keyframe label based on a distance between the keyframe and the global point, and determining a global point label of the global point based on the score.

### CROSS-REFERENCE TO RELATED APPLICATIONS

This application is a Continuation-In-Part application of U.S. Ser. No. 19/338,598, filed Sep. 24, 2025, which claims priority to Korean Patent Application No. 10-2025-0047863, filed Apr. 14, 2025, and U.S. application Ser. No. 19/098,058, filed Apr. 2, 2025, which claims priority to Korean Patent Application No. 10-2024-0142400, filed Oct. 17, 2024, the entire contents of which are incorporated herein by reference.

### TECHNICAL FIELD

The present disclosure relates to a device and method for automatically generating a semantic label map based on keyframe spatial information, and more particularly, the present disclosure relates to a device and method for automatically generating a semantic label map based on keyframe spatial information, which generates a semantic map including label information of the space by fusing semantic information and keyframe label information.

### BACKGROUND

Mobile robots often need to adopt different driving strategies depending on whether they are indoors or outdoors or in specific areas. Accordingly, research is being conducted on efficient and safe driving strategies by distinguishing information about the robot's driving area using computer vision technology and deep learning.

Research is currently being conducted in two major ways. Computer vision methods extract shape information (triangles, squares, circles) from a given raw 2D image map to distinguish between spaces.

As a deep learning method, research is being conducted on projecting object information onto floor plans, which is obtained by model learning through a large amount of learning data, such as, or a 2D map by distinguishing areas through semantic information from image sensors.

Conventional technologies are fundamentally difficult to separate space in non-linear environments (offices and non-linear structural layouts), require a lot of learning data and labeling time in a deep-learning method, and require devices capable of high computation for modeling. This is time-consuming and expensive, and it is difficult for low-specification embedded system-based robots to accurately distinguish spaces, and it is also difficult to distinguish spaces by inferring models.

### SUMMARY

An embodiment of the present disclosure attempts to provide a device and method for automatically generating a semantic label map based on keyframe spatial information, that indexes global point of a semantic map with a KD-tree, finds a nearby point by a keyframe pose-based radius search, updates the label by distance-weighted accumulation scores after visibility verification, and determines a final point label through sorting.

According to various embodiments, a device for automatically generating a semantic label map based on keyframe spatial information may include one or more non-transitory computer-readable media including instructions, and one or more processors configured to perform an operation by executing the instructions, where the operation may include obtaining keyframe data generated through mapping of a robot and global point data of a semantic map, generating a first KD-tree based on the global point data, extracting the global point adjacent to the keyframe by using the first KD-tree and the keyframe data, updating a keyframe label of the keyframe to the global point, determining a score of the keyframe label based on a distance between the keyframe and the global point, and determining a global point label of the global point based on the score.

The obtaining of the keyframe data generated through mapping of the robot and the global point data of the semantic map may include obtaining an image and image position information through a camera and lidar of the robot, and generating the keyframe data and the semantic map by using the image and the image position information.

The generating of the keyframe data and the semantic map by using the image and the image position information may include obtaining keyframe spatial information including keyframe pose data and the keyframe label as the keyframe data through visual-scene aware classification and frame clustering.

The generating of the first KD-tree based on the global point data may include generating the keyframe label in which the score is recorded at each global point and the first KD-tree preserving the global point label in response to an input of the global point.

The extracting of the global point adjacent to the keyframe by using the first KD-tree and the keyframe data may include determining the adjacent global point through a pixel distance-based radius search from the KD-tree based on a keyframe pose data of the keyframe.

The updating of the keyframe label of the keyframe to the global point may include determining whether there exists an obstacle when connecting the keyframe and the adjacent global point based on a keyframe pose data of the keyframe, and updating the keyframe label to the global point when it is determined that there does not exist the obstacle.

The determining of the score of the keyframe label based on the distance between the keyframe and the global point may include determining a correlation for the label to be greater for the global point closer to the keyframe, where the correlation and the score are proportional.

The determining of the score of the keyframe label based on the distance between the keyframe and the global point may include determining a final score by accumulating the score for each keyframe label with respect to a plurality of keyframe labels, when the global point is observed in a plurality of keyframes.

The determining of the global point label of the global point based on the score may include sorting a plurality of keyframe labels updated at the global point based on the score, respectively, and selecting a keyframe label having a greatest score to determine the selected keyframe label as the global point label.

The operation may further include classifying a first global point for which the global point label has been determined and a second global point for which the global point label has not been determined, generating a second KD-tree based on the first global point, extracting at most N first global points closest to a position of the second global point from the second KD-tree, determining whether the extracted first global point and the second global point are connected without an obstacle therebetween, and determining the global point label of the first global point as the global point label of the second global point, when connected.

According to various embodiments, a method for automatically generating a semantic label map based on keyframe spatial information, which is performed by a computing device including a processor and a memory, may include obtaining keyframe data generated through mapping of a robot and global point data of a semantic map, by the processor, generating a first KD-tree based on the global point data, by the processor, determining the global point adjacent to the keyframe by using the first KD-tree and the keyframe data, by the processor, updating a keyframe label of the keyframe to the global point, by the processor, determining a score of the keyframe label based on a distance between the keyframe and the global point, by the processor, and determining a global point label of the global point based on the score, by the processor.

The obtaining of the keyframe data generated through mapping of the robot and the global point data of the semantic map may include obtaining an image and image position information through a camera and lidar of the robot, and obtaining keyframe spatial information including keyframe pose data and the keyframe label as the keyframe data through visual-scene aware classification and frame clustering based on the image and the image position information.

The extracting of the global point adjacent to the keyframe by using the first KD-tree and the keyframe data may include determining the adjacent global point through a pixel distance-based radius search from the first KD-tree based on a keyframe pose data of the keyframe.

The updating of the keyframe label of the keyframe to the global point may include determining whether there exists an obstacle when connecting the keyframe and the adjacent global point based on a keyframe pose data of the keyframe, and updating the keyframe label to the global point when it is determined that there does not exist the obstacle.

The determining of the score of the keyframe label based on the distance between the keyframe and the global point may include determining a correlation for the label to be greater for the global point closer to the keyframe, where the correlation and the score are proportional.

The determining of the score of the keyframe label based on the distance between the keyframe and the global point may include determining a final score by accumulating the score for each keyframe label with respect to a plurality of keyframe labels, when the global point is observed in a plurality of keyframes.

The determining of the global point label of the global point based on the score may include sorting the keyframe label updated at the global point based on the score, respectively, and selecting a keyframe label having a greatest score to determine the selected keyframe label as the global point label.

The method may further include classifying a first global point for which the global point label has been determined and a second global point for which the global point label has not been determined, generating a second KD-tree based on the first global point, extracting at most N first global points closest to a position of the second global point from the second KD-tree, determining whether the extracted first global point and the second global point are connected to each other without an obstacle between, and determining a first global point label of the first global point as a second global point label of the second global point, when the extracted first global point and the second global point are connected to each other without an obstacle between.

The determining of the first global point label of the first global point as the second global point label of the second global point may include updating the first global point label of the first global point to the second global point label of the second global point, determining the score of the first global point label based on the distance between the first global point and the second global point, and finally determining a first global point label having a greatest score among a plurality of updated first global point labels as the second global point label.

According to various embodiments one or more non-transitory computer-readable media including instructions executable by a computing a device is provided, where the instructions causes the computing device to perform an operation, when executed by one or more processors of the computing the device, and where the operation may include obtaining keyframe data generated through mapping of a robot and global point data of a semantic map, generating a KD-tree based on the global point data, determining the global point adjacent to the keyframe by using the KD-tree and the keyframe data, updating a keyframe label of the keyframe to the global point, determining a score of the keyframe label based on a distance between the keyframe and the global point, and determining a global point label of the global point based on the score.

A device and method for automatically generating a semantic label map based on keyframe spatial information according to an embodiment of the present disclosure may extract keyframe spatial information through deep learning based on image information obtained from topology-based 2D semantic mapping, and by using this, may automatically create label information in a 2D semantic map efficiently even in a low-spec embedded system.

A device and method for automatically generating a semantic label map based on keyframe spatial information according to an embodiment of the present disclosure may distinguish nonlinear spaces, and may efficiently generate a semantic map including label information without requiring a large computation load by the coarse-to-fine method.

### BRIEF DESCRIPTION OF THE DRAWINGS

FIG. 1 schematically shows a system for automatically generating a semantic map based on keyframe spatial information according to an embodiment of the present disclosure.

FIG. 2 is a block diagram of a device for automatically generating a semantic label map based on keyframe spatial information according to an embodiment of the present disclosure.

FIG. 3 is a flowchart of a method for automatically generating a semantic label map based on keyframe spatial information according to an embodiment of the present disclosure.

FIG. 4 is a detailed flowchart of the step S30 of FIG. 3 according to an embodiment of the present disclosure.

FIG. 5 is a detailed flowchart of the step S200 of FIG. 4 according to an embodiment of the present disclosure.

FIG. 6 is a detailed flowchart of the step S500 of FIG. 4 according to an embodiment of the present disclosure.

FIG. 7 is an example diagram showing a semantic label map according to an embodiment of the present disclosure.

FIG. 8 is a drawing for explaining an obstacle determining step according to an embodiment of the present disclosure.

FIG. 9 is a drawing for explaining a computing device according to an embodiment of the present disclosure.

### DETAILED DESCRIPTION OF ILLUSTRATIVE EMBODIMENTS

An embodiment of the disclosure will be described more fully hereinafter with reference to the accompanying drawings such that a person skill in the art may easily implement the embodiment. As those skilled in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to distinguish one component from another.

In addition, the terms “unit”, “part” or “portion”, “-er”, and “module” in the specification refer to a unit that processes at least one function or operation, which may be implemented by hardware, software, or a combination of hardware and software.

In addition, at least some components and features of a device and method for automatically generating a semantic label map based on a keyframe spatial information according to embodiments described below may be implemented as a program or software, and the program or software may be stored in a computer-readable medium.

Hereinafter, embodiments of the present disclosure will be described with reference to the drawings.

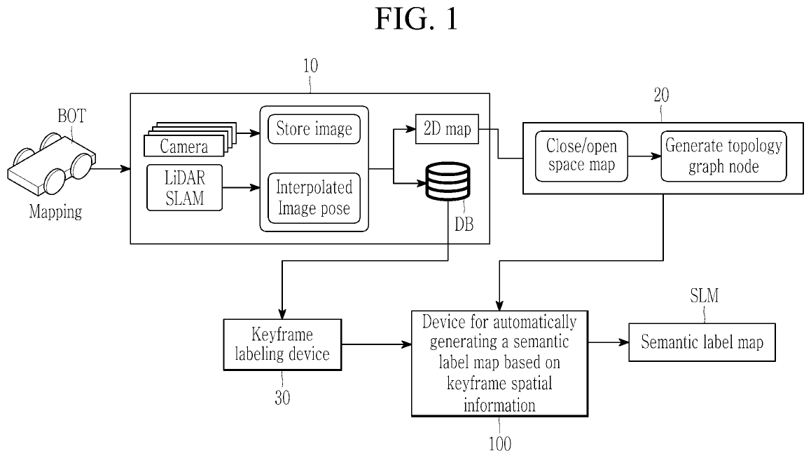

FIG. 1 schematically shows a system for automatically generating a semantic map based on the keyframe spatial information according to an embodiment of the present disclosure.

Referring to FIG. 1, a system for automatically generating the semantic map based on the keyframe spatial information may include a mapping a robot BOT, a data collection device 10, the semantic map generation device 20, the keyframe labeling device 30, and a device 100 for automatically generating the semantic label map based on the keyframe spatial information.

The mapping robot BOT may be a robot that generate a map of a surrounding environment by itself by utilizing sensor data, and drive autonomously based on this map.

The mapping robot BOT may perform mapping by using the simultaneous localization and mapping (SLAM) technology.

The mapping robot BOT may obtain an image, image position information, and map information through mapping.

The data collection device 10 may collect data or information obtained from the mapping robot BOT. The data collection device 10 may include a database DB.

The data collection device 10 may store the image, the image position information, an image keyframe information, and 2D map, or the like obtained through mapping in the database DB.

The data collection device 10 may collect and store surrounding environment information by utilizing data of camera, lidar, infrared sensor, or the like, mounted on the mapping robot BOT.

The semantic map generation device 20 may receive the image, the image position information, and the 2D map from the data collection device 10, to generate the semantic map.

The semantic map generation device 20 may generate an open topology space and a close topology space by using binarization processing for the received image.

The open topology space may be an open space that a robot can pass through, and the open topology space may be a space that a robot cannot pass through.

The semantic map generation device 20 may generate a topology graph node by using the open topology space and the close topology space, and generate the semantic map by using the topology graph node.

The topology graph node may be a node for the region that the robot can pass through considering the size of the robot in the open topology space.

The semantic map may be a map that is semantically spatially distinct. The semantic map may include a plurality of global points.

The semantic map generation device 20 may provide the global point of the generated semantic map to the device 100 for automatically generating the semantic label map based on the keyframe spatial information.

The keyframe labeling device 30 may extract spatial information of each keyframe by using visual-scene aware classification.

The keyframe labeling device 30 may receive the keyframe and the keyframe pose from the database DB storing the image keyframe information of the data collection device 10, to generate the keyframe label through visual-scene aware classification and clustering.

The keyframe labeling device 30 may provide the keyframe, the keyframe label and the keyframe pose to the device 100 for automatically generating the semantic label map based on the keyframe spatial information.

The device 100 for automatically generating the semantic label map based on the keyframe spatial information may fuse the semantic map information (the global point) and the keyframe label information (the keyframe pose, the keyframe label), to generate the semantic label map 200 including label information for the space.

That is, the device 100 for automatically generating the semantic label map based on the keyframe spatial information may determine a global point label based on the keyframe label for each global point of the semantic map, and generate the semantic label map 200 based on the determined global point label.

That is, the semantic label map 200 may be the semantic map attached with a label for each space (or point).

The semantic label map 200 may automatically distinguish the space on the map through the global point label.

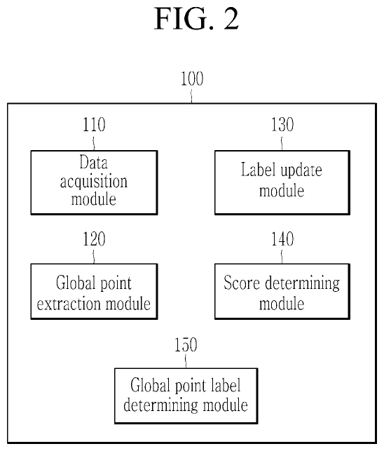

FIG. 2 is a block diagram of a device for automatically generating the semantic label map based on the keyframe spatial information according to an embodiment of the present disclosure.

The device 100 for automatically generating the semantic label map based on the keyframe spatial information according to an embodiment may be implemented as a computing device including a processor and a memory.

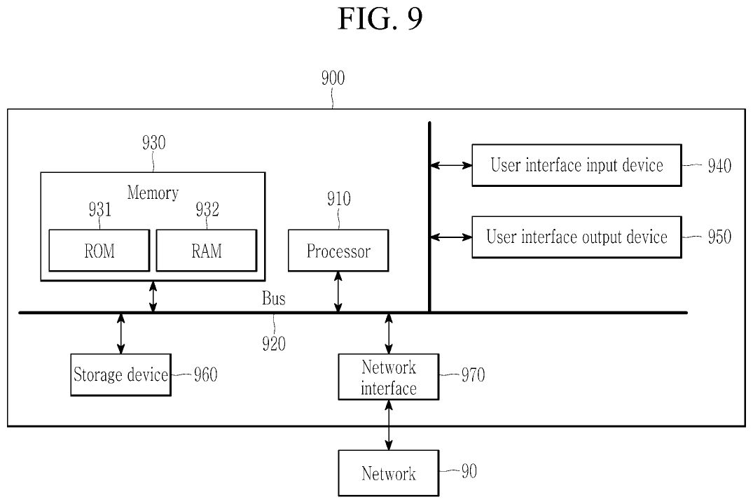

For example, the device 100 for automatically generating the semantic label map based on the keyframe spatial information may be implemented as a computing device 900 described later with reference to FIG. 9. In this case, the processor may correspond to a processor 910 of the computing device 900, and the memory may correspond to a memory 930 of the computing device 900.

Alternatively, in some embodiments, the device 100 for automatically generating the semantic label map based on the keyframe spatial information may include one or more non-transitory computer-readable media including instructions and one or more processors configured to perform an operation by executing the instructions.

Here, the operation may include a configuration, a function, a step, or the like, described in this specification with respect to a device and method for automatically generating the semantic label map based on the keyframe spatial information according to embodiments.

In this specification, the term “module” is used in order to logically differentiate these operations performed by a device and method for automatically generating the semantic label map based on the keyframe spatial information according to embodiments.

Referring to FIG. 2, the device 100 for automatically generating the semantic label map based on the keyframe spatial information may include a data acquisition module 110, the global point extraction module 120, a label update module 130, a score determining module 140 and the global point label determining module 150.

The data acquisition module 110 may obtain keyframe data generated through mapping of the robot and global point data of the semantic map. Here, the global point data may be node data extracted from the semantic map where the robot driveable.

The data acquisition module 110 may obtain the image and the image position information through the camera and lidar of the robot, and generate the keyframe data and the semantic map by using the image and the image position information.

The data acquisition module 110 may obtain the keyframe spatial information including the keyframe pose data and the keyframe label through visual-scene aware classification and frame clustering as the keyframe data.

In addition, the data acquisition module 110 may obtain the global point data and the keyframe data from the semantic map generation device 20 and the keyframe labeling device 30 of FIG. 1, respectively.

The global point extraction module 120 may generate a KD-tree based on the global point data.

The global point extraction module 120 may generate the keyframe label in which score is recorded at each global point and the KD-tree preserving a global point label in response to an input of the global point.

The KD-tree is a spatial division data structure for efficiently structuralizing the points of the K-dimensional space. The KD-tree is an extension of a binary search tree, where each node divides the space into two regions, and this process is repeated recursively.

The KD-tree may include the global point in th node. Afterwards, the global point of each node may include the keyframe label information in which the score is recorded.

The global point extraction module 120 may extract the global point adjacent to the keyframe by using the KD-tree and the keyframe data.

The global point extraction module 120 may determine the adjacent global point through a pixel distance-based radius search from the KD-tree based on the keyframe pose data of the keyframe.

For example, the global point extraction module 120 may determine the global points within a radius of 50 pixels from the camera pose (R, t) of the keyframe in the KD-tree, as the adjacent global point.

The label update module 130 may update the keyframe label of the keyframe to the global point.

When connecting the global point adjacent to the keyframe based on the keyframe pose data of the keyframe, the label update module 130 may determine whether there exists an obstacle.

For example, the label update module 130 may perform a collision test on a light ray directed from the keyframe to the adjacent global point.

When it is determined that there does not exist an obstacle, the label update module 130 may update the keyframe label of the corresponding keyframe to the adjacent global point.

The score determining module 140 may determine a score of the keyframe label based on a distance between the keyframe and the global point.

The score determining module 140 may calculate the score by using Equation 1. Equation 1 may be a linear decaying function calculating a distance-based weight value.

$$w = max ( 0 , 1 - \frac{distance}{max\_distance} ) \qquad [ Equation 1 ]$$

Here, “distance” may be an actual distance between the keyframe pose (or, camera pose position) and the adjacent global points, max_distance may be an effective maximum distance, and w may be the weight value (i.e., a score, a value between 0 and 1) to be used in the label propagation.

For example, the max_distance may be 50. At this time, Equation 1 is a decaying (weight) function that starts from 1 at distance 0, and linearly decreases up to a distance of 50 units.

The score determining module 140 may adjust the spatial reliability of the keyframe label based on the distance through Equation 1.

The score determining module 140 may determine the correlation for the label to be greater for the global point closer to the keyframe. The correlation and the score may be proportional.

That is, the score determining module 140 may determine a larger score of the keyframe label to be updated at the corresponding global point, for a global point closer to the keyframe.

When the global point is observed in a plurality of keyframes, the score determining module 140 may determine a final score by accumulating score for each the keyframe label with respect to a plurality of keyframe labels.

That is, when the keyframe label with recording of previously updated score at the global point exists and the keyframe label updated at this time is the same label, the score determining module 140 may add the score calculated this time to the previously recorded score.

The global point is a point of the same spatial position (e.g., one point on a certain road surface), and the keyframe label is a result of the semantic class prediction of that point viewed from the camera at a specific time point.

For example, when the same global point P are supposed to be observed in three keyframes KF1, KF2, and KF3, the score determining module 140 may accumulate the score of the keyframe label obtained in each observation.

For example, assumed a situation in which a first keyframe label of a first keyframe is road and has a prediction reliability (conf) of 0.9 and a score of 0.95, a second keyframe label of a second keyframe is the same road and has a prediction reliability of 0.8 and a score of 0.8, and a third keyframe label of a third keyframe is sidewalk and has a prediction reliability of 0.7 and a score of 0.5.

The keyframe labels of the first keyframe and the second keyframe are the same as road, and only the keyframe label of the third keyframe is different as sidewalk.

The score determining module 140 may add all scores of the road keyframe label. Therefore, the score of the road keyframe label may be (0.9×0.95)+(0.8×0.8)=1.5.

At this time, the score of the sidewalk keyframe label may be 0.7×0.5=0.35.

The global point label determining module 150 may determine the global point label of the global point based on the score.

The global point label determining module 150 may sort the plurality of keyframe labels updated at the global point based on the score, respectively.

The global point label determining module 150 may select the keyframe label having a greatest score and determine it as the global point label.

For example, the global point label determining module 150 may finally determine the road keyframe label having the accumulation score of 1.51 as the global point label with respect to the global point.

Afterwards, the global point label determining module 150 may classify a first global point for which the global point label has been determined and a second global point for which the global point label has not been determined.

The global point label determining module 150 may generate a second KD-tree based on the first global point.

The global point label determining module 150 may extract at most N first global points closest to a position of the second global point from the KD-tree based on the second global point. At this time, radius search may not be used.

The global point label determining module 150 may determine whether the extracted first global point and the second global point are connected without an obstacle therebetween.

When the extracted first global point and the second global point are connected without an obstacle therebetween, the global point label determining module 150 may determine the global point label of the first global point as the global point label of the second global point.

At this time also, the global point label determining module 150 may finally determine a second global point label based on scores of a plurality of first global point labels with respect to the adjacent first global points.

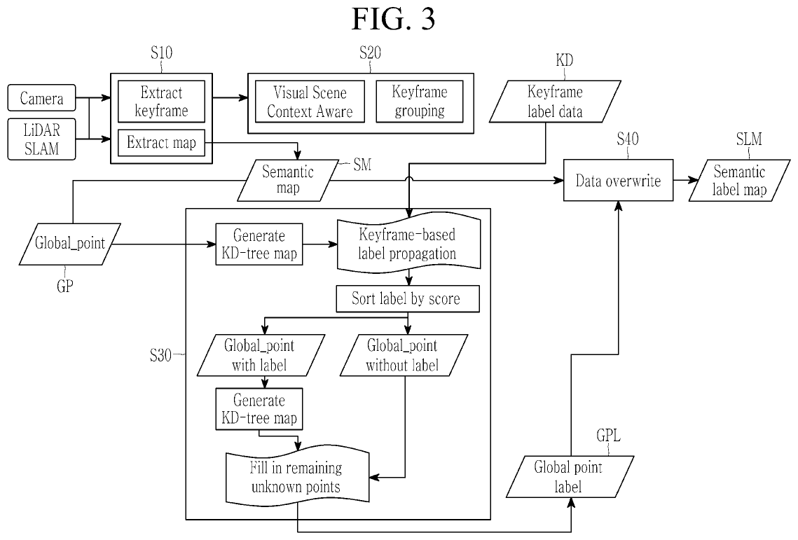

FIG. 3 to FIG. 6 are drawings for explaining a method for automatically generating the semantic label map based on the keyframe spatial information. A method for automatically generating the semantic label map based on the keyframe spatial information of FIG. 3 to FIG. 6 may be performed by the device 100 for automatically generating the semantic label map based on the keyframe spatial information of FIG. 2.

FIG. 3 is an entire flowchart of a method for automatically generating the semantic label map based on the keyframe spatial information according to an embodiment of the present disclosure.

In FIG. 3, the device 100 for automatically generating the semantic label map based on the keyframe spatial information may extract the keyframe and the semantic map SM collected through the mapping of the robot based on the camera and the lidar, at step S10.

The device 100 for automatically generating the semantic label map based on the keyframe spatial information may obtain the keyframe spatial information including the keyframe pose data and the keyframe label as the keyframe data (KD) through visual-scene aware classification and frame clustering, with respect to the extracted keyframe, at step S20.

The device 100 for automatically generating the semantic label map based on the keyframe spatial information may generate a global point label GPL through the KD-tree generation and label propagation process based on a global point GP and the keyframe data (KD) extracted from the semantic map SM, at step S30.

The device 100 for automatically generating the semantic label map based on the keyframe spatial information may finally generate a semantic label map SLM through data overwriting the generated global point label GPL in the semantic map SM, at step S40.

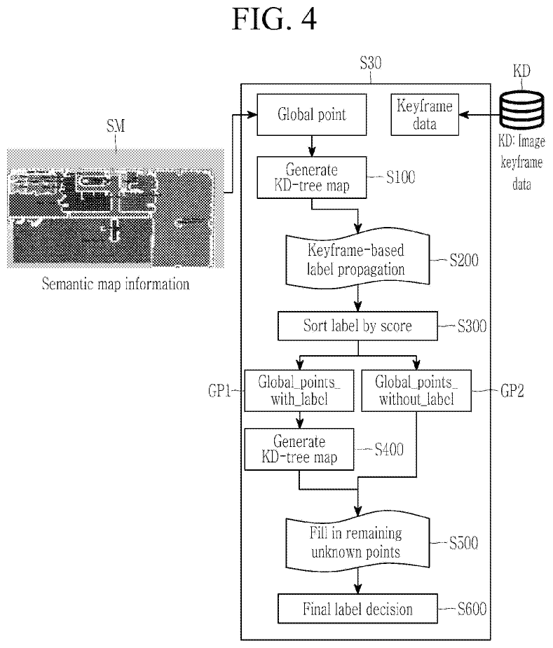

FIG. 4 is a detailed flowchart of the step S30 of FIG. 3 according to an embodiment of the present disclosure. That is, FIG. 4 is a key flowchart for explaining a method for automatically generating the semantic label map based on the keyframe spatial information according to an embodiment of the present disclosure.

In FIG. 4, the device 100 for automatically generating the semantic label map based on the keyframe spatial information may generate a KD-tree based on the obtained global point data, at step S100.

The device 100 for automatically generating the semantic label map based on the keyframe spatial information may perform the keyframe-based label propagation with respect to the adjacent keyframe and the adjacent global point by using the KD-tree and the keyframe data, at step S200.

The device 100 for automatically generating the semantic label map based on the keyframe spatial information may update the keyframe label for the global point through the keyframe-based label propagation.

The device 100 for automatically generating the semantic label map based on the keyframe spatial information may determine the scores based on the distance with respect to the updated keyframe labels, and sort the plurality of keyframe labels by using the score, at step S300.

The device 100 for automatically generating the semantic label map based on the keyframe spatial information may finally determine the global point label for the global point based on the score from among the sorted keyframe labels.

Afterwards, the device 100 for automatically generating the semantic label map based on the keyframe spatial information may classify a first global point for which the global point label has been determined GP1 and a second global point for which the global point label has not been determined GP2.

The device 100 for automatically generating the semantic label map based on the keyframe spatial information may generate a KD-tree based on the first global point GP1 for which the label is determined, at step S400.

The device 100 for automatically generating the semantic label map based on the keyframe spatial information may perform an update of the label of the second global point GP2 for which the label is not determined by using the KD-tree of the first global point GP1, at step S500.

When the labeling is completed up to the second global point GP2, the device 100 for automatically generating the semantic label map based on the keyframe spatial information may finally determine the global point label with respect to all the global points, at step S600.

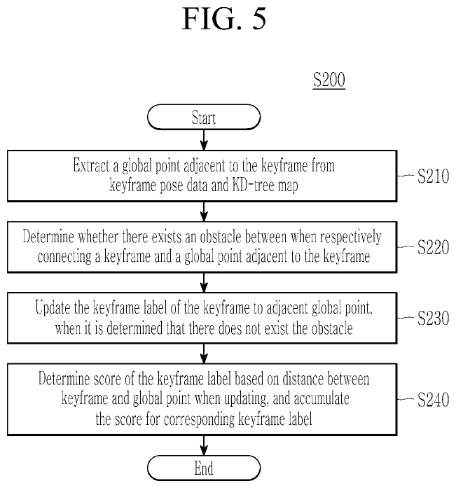

FIG. 5 is a detailed flowchart of the step S200 of FIG. 4 according to an embodiment of the present disclosure. That is, FIG. 5 is a drawing for explaining the keyframe-based label propagation step.

In FIG. 5, the device 100 for automatically generating the semantic label map based on the keyframe spatial information may extract the global point adjacent to the keyframe from the keyframe pose data and the KD-tree map, at step S210.

The device 100 for automatically generating the semantic label map based on the keyframe spatial information may determine the adjacent global point through a pixel distance-based radius search from the KD-tree based on the keyframe pose data of the keyframe.

The device 100 for automatically generating the semantic label map based on the keyframe spatial information may determine whether there exists an obstacle therebetween when respectively connecting the keyframe and the global point adjacent to the keyframe, at step S220.

When it is determined that there does not exist an obstacle, the device 100 for automatically generating the semantic label map based on the keyframe spatial information may update the keyframe label of the keyframe to the adjacent global point, at step S230.

When updating, the device 100 for automatically generating the semantic label map based on the keyframe spatial information may determine the score of the keyframe label based on the distance between the keyframe and the global point, and accumulate the score for the corresponding keyframe label, at step S240.

The device 100 for automatically generating the semantic label map based on the keyframe spatial information may determine the correlation for the label to be greater for the global point closer to the keyframe. The correlation and the score may be proportional.

When the global point is observed in the plurality of keyframes, the device 100 for automatically generating the semantic label map based on the keyframe spatial information may determine the final score by accumulating the score for each keyframe label with respect to the plurality of keyframe labels.

The device 100 for automatically generating the semantic label map based on the keyframe spatial information may sort the keyframe labels updated at the global point based on the score.

The device 100 for automatically generating the semantic label map based on the keyframe spatial information may select the keyframe label having a greatest score and determine it as the global point label.

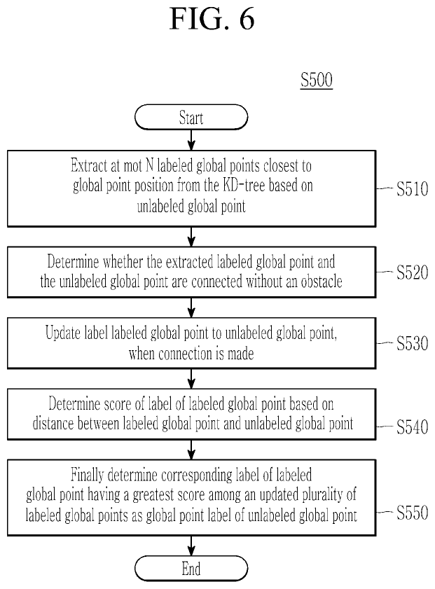

FIG. 6 is a detailed flowchart of the step S500 of FIG. 4 according to an embodiment of the present disclosure. That is, FIG. 6 is a drawing for explaining a final step of filling labels in remaining global points whose labels are unknown.

In FIG. 6, the device 100 for automatically generating the semantic label map based on the keyframe spatial information may extract at most N (e.g., 50) labeled global points closest to a position of the unlabeled global point from the KD-tree based on an unlabeled global point, at step S510.

The device 100 for automatically generating the semantic label map based on the keyframe spatial information may determine whether the extracted labeled global point and the unlabeled global point are connected without an obstacle therebetween, at step S520.

When the connection is made, the device 100 for automatically generating the semantic label map based on the keyframe spatial information may update (label update) the label of the labeled global point to the unlabeled global point, at step S530.

At this time, the device 100 for automatically generating the semantic label map based on the keyframe spatial information may determine label score of the labeled global point based on the distance between the labeled global point and the unlabeled global point, at step S540.

Even in this case, the device 100 for automatically generating the semantic label map based on the keyframe spatial information may sum and accumulate the scores when updating the labels of the same plurality of labels of the labeled global points.

The device 100 for automatically generating the semantic label map based on the keyframe spatial information may finally determine a label of the labeled global point having a greatest label score among a plurality of updated labeled global points as the global point label of the unlabeled global point, at step S550.

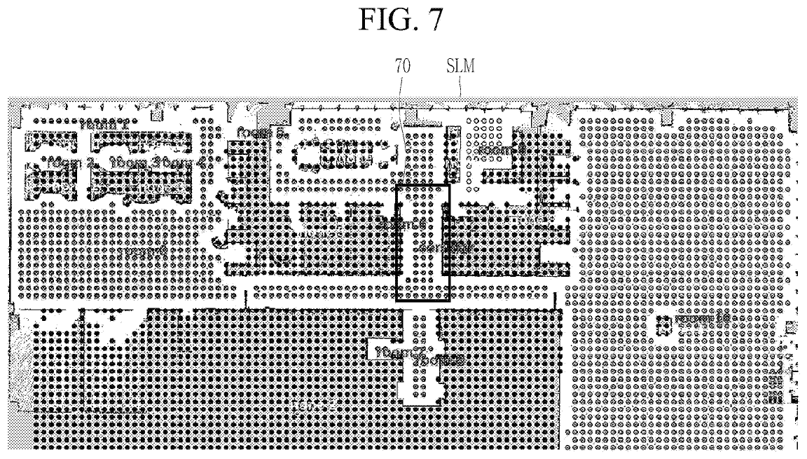

FIG. 7 is an example diagram showing the semantic label map according to an embodiment of the present disclosure.

The semantic label map SLM is one obtained by overwriting the global point label in the conventional semantic map.

That is, the semantic label map SLM may include label information on each of the global points on the map.

The semantic label map SLM may automatically indicate labels for the global points on the map.

For example, when a certain region 70 is selected on the map, the semantic label map SLM may display a corridor, which is a predetermined label.

The device 100 for automatically generating the semantic label map based on the keyframe spatial information may determine the label information with respect to the global points on the semantic map, generate the semantic label map SLM, and automatically display it when necessary.

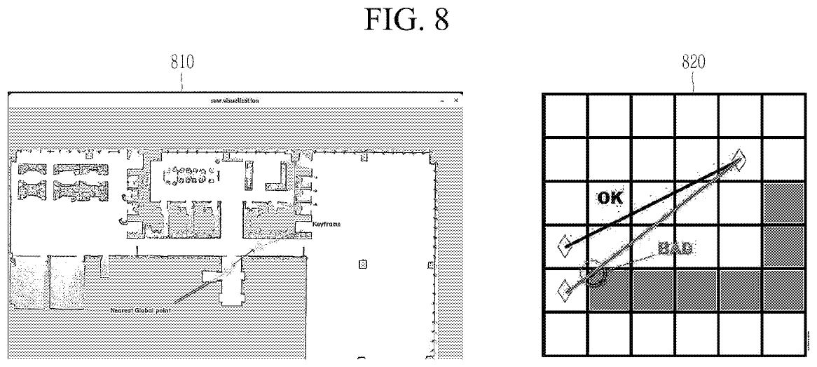

FIG. 8 is a drawing for explaining an obstacle determining step according to an embodiment of the present disclosure.

According to an embodiment, the device 100 for automatically generating the semantic label map based on the keyframe spatial information may determine whether there exists an obstacle, when pose data of the surrounding adjacent global point are respectively connected based on the keyframe pose data.

For example, the device 100 for automatically generating the semantic label map based on the keyframe spatial information may check whether an obstacle exists at a connection point, by using Bresenham's line algorithm (Bresenham's line check (keyframe_pose, nearest global point)).

The Bresenham's line algorithm is an algorithm for determining an optimal pixel position when drawing a straight line connecting two points in computer graphics.

In FIG. 8, with respect to a certain region 810 on the semantic map, the connected line may be indicated as OK, the line that cannot be connected to due to the obstacle may be indicated as BAD (refer to 820).

FIG. 9 is a drawing for explaining the computing device according to an embodiment of the present disclosure.

Referring to FIG. 9, a device and method for automatically generating the semantic label map based on the keyframe spatial information according to embodiments may be implemented by using the computing device 900.

The computing device 900 may include at least one of the processor 910, the memory 930, a user interface input device 940, a user interface output device 950, and a storage device 960 that communicate through a bus 920. The computing device 900 may also include a network interface 970 electrically connected to a network 90. The network interface 970 may transmit or receive signal with other entities through the network 90.

The processor 910 may be implemented as various types of computational devices, for example, various types such as a micro controller unit (MCU), an application processor (AP), a central processing unit (CPU), a graphics processing unit (GPU), a neural processing unit (NPU), or the like, and may be any type of semiconductor device capable of executing instructions stored in the memory 930 or the storage device 960. The processor 910 may be configured to implement the functions and methods described above with reference to FIG. 1 to FIG. 8.

The memory 930 and the storage device 960 may include various types of volatile or non-volatile storage media. For example, memory may include a read-only memory (ROM) 931 and a random-access memory (RAM) 932. In the present embodiment, the memory 930 may be located inside or outside the processor 910, and the memory 930 may be connected to the processor 910 through already known various means.

The memory 930 may be connected to the processor 910 through various data buses or interfaces. This connection may be made through already known various means, for example, a Peripheral Component Interconnect Express (PCIe) interface for high-rate data transmission or a memory controller.

In some embodiments, at least some components and features of a device and method for automatically generating the semantic label map based on the keyframe spatial information according to embodiments may be implemented as a program or software executed by the computing device 900, and the program or software may be stored in a computer-readable medium.

In more detail, a computer-readable medium according to an embodiment may record a program for causing a computer including the processor 910 executing program or instructions stored in the memory 930 or the storage device 960 to execute steps included in an implementation of a device and method for automatically generating the semantic label map based on the keyframe spatial information according to embodiments.

In some embodiments, at least some components and features of a device and method for automatically generating the semantic label map based on the keyframe spatial information according to embodiments may be implemented using hardware or circuitry of the computing device 900, or may be implemented as separate hardware or circuitry that can be electrically connected to the computing device 900.

In some embodiments, one or more non-transitory computer-readable media that include instructions executable by the computing device 900 are provided, and the instructions may cause the computing device 900 to perform the operation, when executed by one or more processors of the computing device 900. Here, the operation may include components, features, steps, or the like, described in this specification with respect to a device and method for automatically generating the semantic label map based on the keyframe spatial information according to embodiments.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of appended claims.

What is claimed is:

1. A device for automatically generating a semantic label map based on keyframe spatial information, the device comprising:
one or more processors; and
one or more non-transitory computer-readable media with instructions stored thereon, wherein the instructions, when executed by the one or more processors, enable the device to perform:
obtaining keyframe data generated through mapping by a robot and global point data of a semantic map;
generating a first keyframe data (KD)-tree based on the global point data;
extracting a global point adjacent to a keyframe by using the first KD-tree and the keyframe data;
assigning a keyframe label of the keyframe to the global point;
determining a score of the keyframe label based on a distance between the keyframe and the global point; and
determining a global point label of the global point based on the score.

2. The device of claim 1, wherein obtaining the keyframe data generated through mapping by the robot and the global point data of the semantic map comprises:
obtaining an image and image position information through a camera and lidar of the robot; and
generating the keyframe data and the semantic map by using the image and the image position information.

3. The device of claim 2, wherein generating the keyframe data and the semantic map by using the image and the image position information comprises
obtaining keyframe spatial information comprising keyframe pose data and the keyframe label as the keyframe data through visual-scene aware classification and frame clustering.

4. The device of claim 1, wherein generating the first KD-tree based on the global point data comprises
generating the keyframe label in which the score is recorded at each global point and the first KD-tree preserving the global point label in response to an input of the global point.

5. The device of claim 1, wherein extracting the global point adjacent to the keyframe by using the first KD-tree and the keyframe data comprises
determining the adjacent global point through a pixel distance-based radius search from the KD-tree based on a keyframe pose data of the keyframe.

6. The device of claim 1, wherein assigning the keyframe label of the keyframe to the global point comprises:
determining whether there is an obstacle when connecting the keyframe and the adjacent global point based on a keyframe pose data of the keyframe; and
assigning the keyframe label to the global point when determining that the obstacle does not exist.

7. The device of claim 1, wherein determining the score of the keyframe label based on the distance between the keyframe and the global point comprises:
determining a correlation for the label to be greater for the global point closer to the keyframe,
wherein the correlation and the score are proportional.

8. The device of claim 1, wherein determining the score of the keyframe label based on the distance between the keyframe and the global point comprises
determining a final score by accumulating the score for each keyframe label with respect to a plurality of keyframe labels, when the global point is observed in a plurality of keyframes.

9. The device of claim 1, wherein determining the global point label of the global point based on the score comprises:
sorting a plurality of keyframe labels assigned at the global point based on the score, respectively; and
selecting a keyframe label having a greatest score to determine the selected keyframe label as the global point label.

10. The device of claim 1, wherein the device is further enabled to perform:
classifying a first global point for which the global point label has been determined and a second global point for which the global point label has not been determined;
generating a second KD-tree based on the first global point;
extracting at most N first global points closest to a position of the second global point from the second KD-tree;
determining whether the extracted first global point and the second global point are connected without an obstacle between the first global point and the second global point; and
determining the global point label of the first global point as the global point label of the second global point, when first global point and the second global point are connected.

11. A method for automatically generating a semantic label map based on keyframe spatial information, the method comprising:
obtaining, by a processor, keyframe data generated through mapping by a robot and global point data of a semantic map;
generating, by the processor, a first keyframe data (KD)-tree based on the global point data;
determining, by the processor, a global point adjacent to a keyframe by using the first KD-tree and the keyframe data;
assigning, by the processor, a keyframe label of the keyframe to the global point;
determining, by the processor, a score of the keyframe label based on a distance between the keyframe and the global point; and
determining, by the processor, a global point label of the global point based on the score.

12. The method of claim 11, wherein obtaining the keyframe data generated through mapping by the robot and the global point data of the semantic map comprises:
obtaining an image and image position information through a camera and lidar of the robot; and
obtaining keyframe spatial information comprising keyframe pose data and the keyframe label as the keyframe data through visual-scene aware classification and frame clustering based on the image and the image position information.

13. The method of claim 11, wherein extracting the global point adjacent to the keyframe by using the first KD-tree and the keyframe data comprises
determining the adjacent global point through a pixel distance-based radius search from the first KD-tree based on a keyframe pose data of the keyframe.

14. The method of claim 11, wherein updating the keyframe label of the keyframe to the global point comprises:
determining whether there is an obstacle when connecting the keyframe and the adjacent global point based on a keyframe pose data of the keyframe; and
assigning the keyframe label to the global point when determining that there the obstacle does not exist.

15. The method of claim 11, wherein determining the score of the keyframe label based on the distance between the keyframe and the global point comprises:
determining a correlation for the label to be greater for the global point closer to the keyframe,
wherein the correlation and the score are proportional.

16. The method of claim 11, wherein determining the score of the keyframe label based on the distance between the keyframe and the global point comprises
determining a final score by accumulating the score for each keyframe label with respect to a plurality of keyframe labels, when the global point is observed in a plurality of keyframes.

17. The method of claim 11, wherein determining the global point label of the global point based on the score comprises:
sorting the keyframe label assigned at the global point based on the score, respectively; and
selecting a keyframe label having a greatest score to determine the selected keyframe label as the global point label.

18. The method of claim 11, further comprising:
classifying a first global point for which the global point label has been determined and a second global point for which the global point label has not been determined;
generating a second KD-tree based on the first global point;
extracting at most N first global points closest to a position of the second global point from the second KD-tree;
determining whether the extracted first global point and the second global point are connected to each other without an obstacle between the first global point and the second global point; and
determining a first global point label of the first global point as a second global point label of the second global point, when the extracted first global point and the second global point are connected to each other without the obstacle.

19. The method of claim 18, wherein determining the first global point label of the first global point as the second global point label of the second global point comprises:
assigning the first global point label of the first global point to the second global point label of the second global point;
determining the score of the first global point label based on the distance between the first global point and the second global point; and
finally determining a first global point label having a greatest score among a plurality of assigned first global point labels as the second global point label.

20. A non-transitory computer-readable medium having instructions stored thereon, wherein the instructions, when executed by a processor of a device, cause the device to perform:
obtaining keyframe data generated through mapping by a robot and global point data of a semantic map;
generating a keyframe data (KD)-tree based on the global point data;
determining a global point adjacent to a keyframe by using the KD-tree and the keyframe data;
assigning a keyframe label of the keyframe to the global point;
determining a score of the keyframe label based on a distance between the keyframe and the global point; and
determining a global point label of the global point based on the score.
